(19) United States
(12) Patent Application Publication
(10) Pub. No.: US 2020/0152039 A1
(43) Pub. Date: May 14, 2020

(54) IMAGE MANAGEMENT DEVICE, COMPUTER-READABLE STORAGE MEDIUM, IMAGE MANAGEMENT METHOD, AND ARTICLE

(71) Applicant: HONDA MOTOR CO.,LTD., Tokyo (JP)

(72) Inventors: Shinichi KASAHARA, Saitama (JP); Toshikatsu KURAMOCHI, Tokyo (JP)

(21) Appl. No.: 16/677,675

(22) Filed: Nov. 8, 2019

(30) Foreign Application Priority Data
Nov. 13, 2018 (JP) 2018-213293

(51) Int. Cl. G08B 21/02; G08B 25/01; G06K 7/14

(52) U.S. Cl. CPC G08B 21/0288; G08B 21/0205; G06K 7/1443; G06K 7/1417; G08B 21/0269; G08B 25/016

(57) ABSTRACT

An image management device is provided. The device includes an image data acquisition unit configured to acquire image data of an image, which is captured by an imaging unit mounted on a moving object and configured to capture an outside situation of the moving object; a determination unit configured to analyze the image data and to determine whether an encoded code, in which predetermined information is encoded in a predetermined format, is included in the image; and a transmission unit configured to, when it is determined that the encoded code is included in the image, transmit at least one of at least a part of the predetermined information and the image data to a code information collection device configured to collect information about the encoded code.

The contents of the following Japanese patent application are incorporated herein by reference:

NO. 2018-213293 filed in JP on Nov. 13, 2018

### BACKGROUND

### 1. Technical Field

The present invention relates to an image management device, a computer-readable storage medium, an image management method, and an article.

### 2. Related Art

Known is technology of distributing a QR code (registered trademark) to a child at an event site such as a theme park, capturing the QR code by a mobile terminal when the child gets lost and easily giving the lost child to a protector (for example, refer to Patent Document 1).

### CITATION LIST

### [Patent Document]

### [Patent Document 1]

Japanese Patent Application Publication No. 2007-011555

### BRIEF DESCRIPTION OF THE DRAWINGS

FIG. 1 shows schematically an example of a system configuration of a management system 100.

FIG. 2 shows schematically an example of an internal configuration of a management server 110.

FIG. 3 shows schematically an example of an internal configuration of a vehicle 120.

FIG. 4 shows schematically an example of an internal configuration of an image management unit 124.

FIG. 5 shows schematically an example of an outer appearance of a student 50.

FIG. 6 shows schematically an example of an internal configuration of an output data generation unit 270.

FIG. 7 shows schematically an example of an acquisition method of an image of a runner 70.

FIG. 8 shows schematically an example of an internal configuration of an output data generation unit 870.

FIG. 9 shows schematically an example of an acquisition method of an image of a facility 920.

FIG. 10 shows schematically an example of an internal configuration of an output data generation unit 1070.

### DESCRIPTION OF EXEMPLARY EMBODIMENTS

Hereinbelow, embodiments of the present invention will be described. However, the embodiments do not limit the invention defined in the claims. Also, all combinations of features described in the embodiments are not necessarily essential to solving means of the invention. In the drawings, the same or similar parts are denoted with the same reference signs, and the overlapping descriptions thereof may be omitted.

### [Outline of Management System 100]

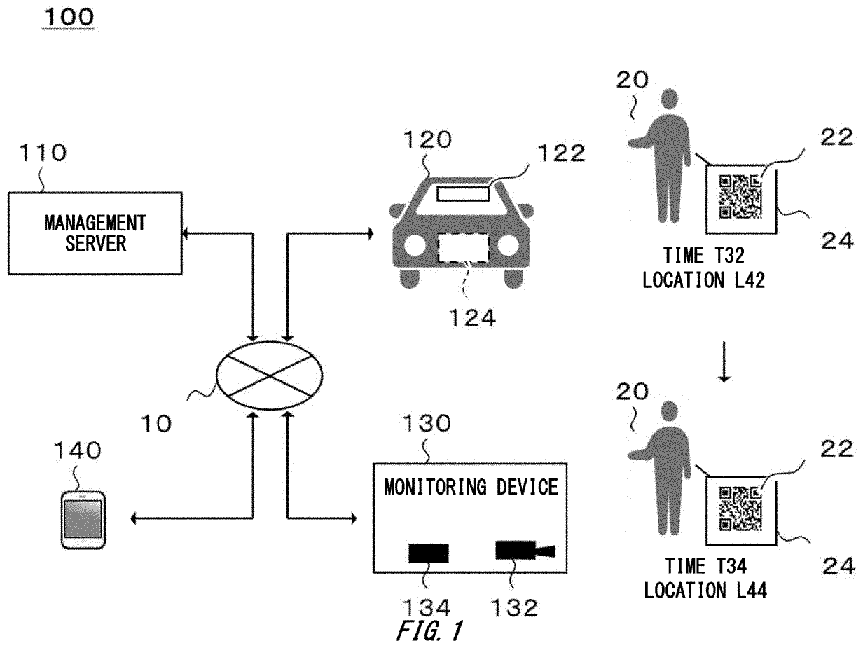

FIG. 1 shows schematically an example of a system configuration of a management system 100. In the present embodiment, the management system 100 includes a management server 110, a vehicle 120, and a monitoring device 130. The management system 100 may include a communication terminal 140 that is to be used by a user of the management system 100. In the present embodiment, the vehicle 120 includes an outside-of-vehicle imaging unit 122, and an image management unit 124. In the present embodiment, the monitoring device 130 includes a monitoring camera 132, and an image management unit 134.

In the present embodiment, the management server 110 and the vehicle 120 can transmit and receive information each other via a communication network 10. The management server 110 and the monitoring device 130 can transmit and receive information each other via the communication network 10. The management server 110 and the communication terminal 140 may be configured to transmit and receive information each other via the communication network 10. At least one of the vehicle 120 and the monitoring device 130 and the communication terminal 140 may be configured to transmit and receive information each other via the communication network 10.

The management server 110 may be configured to manage image data of an image captured by the outside-of-vehicle imaging unit 122 or the monitoring camera 132. The management server 110 may be configured to manage information about a photographic subject of the image captured by the outside-of-vehicle imaging unit 122 or the monitoring camera 132. The management server 110 is configured to monitor a monitoring target 20 or a personal item 24 of the monitoring target 20. The management server 110 may be configured to manage image data of an image in which the monitoring target 20 or the personal item 24 of the monitoring target 20 is captured. The management server 110 may be configured to manage a position or moving history of the monitoring target 20 or the personal item 24 of the monitoring target 20.

In the present embodiment, a QR code 22 is arranged on a part of the monitoring target 20 or the personal item 24 of the monitoring target 20. The monitoring target 20 and the personal item 24 may be examples of a management target or a monitoring target of the management system 100. In the meantime, a method of providing the QR code 22 is not particularly limited. The QR code 22 may be printed or painted, bonded or impressed on the personal item 24.

In the present embodiment, when the QR code 22 is recognized in an image captured by the outside-of-vehicle imaging unit 122, the image management unit 124 decodes the QR code 22, and transmits at least one of identification information for identifying the QR code and data of the image (also referred to as ‘image data’) to the management server 110, for example. The image management unit 124 may be configured to transmit information, which indicates a location and a time on which the QR code has been captured, to the management server 110, together with the above information or data.

Likewise, when the QR code 22 is recognized in an image captured by the monitoring camera 132, the image management unit 134 decodes the QR code 22, and transmits at least one of the identification information of the QR code and the image data of the image to the management server 110, for example. The image management unit 134 may be configured to transmit information, which indicates a location and a time on which the QR code has been captured, to the management server 110, together with the above information or data.

For example, in a case in which the monitoring target 20 exists at a location L42 at time T32, the monitoring target 20 is photographed in an image captured by the outside-of-vehicle imaging unit 122 of the vehicle 120 having passed near the same location at same time. When the image management unit 124 recognizes the QR code 22 by analyzing the image, the image management unit 124 decodes the QR code 22 to acquire the identification information of the QR code 22 and address information of the management server 110. Then, the image management unit 124 transmits the identification information of the QR code 22, and information, which indicates the location and time on which the image has been captured, to the management server 110. The image management unit 124 may transmit the image to the management server 110.

Likewise, in a case in which the monitoring target 20 exists at a location L44 at time T34, the monitoring target 20 is photographed in an image captured by the monitoring camera 132 of the monitoring device 130 arranged near the location L44 at same time. Then, the image management unit 134 transmits the identification information of the QR code 22, and information, which indicates the location and time on which the image has been captured, to the management server 110, in accordance with the similar procedure to the image management unit 124. The image management unit 134 may transmit the image to the management server 110.

According to the present embodiment, the image management unit 124 or the image management unit 134 is configured to automatically extract the image having the QR code 22 photographed therein from the image captured by the outside-of-vehicle imaging unit 122 or the monitoring camera 132. In one embodiment, the image management unit 124 or the image management unit 134 is configured to transmit image data of the extracted image to the management server 110. In another embodiment, the image management unit 124 or the image management unit 134 is configured to decode the QR code 22 included in the extracted image, thereby acquiring information or command encoded by the QR code 22. The image management unit 124 or the image management unit 134 is configured to execute processing corresponding to contents of the information or command. For example, the image management unit 124 or the image management unit 134 is configured to associate the identification information for identifying the QR code and the information, which indicates a location and a time on which the image including the QR code has been captured, and transmit the same to the management server 110.

Thereby, according to the management system 100 of the present embodiment, even if a user of a mobile terminal having a camera function, for example, does not capture the monitoring target 20 by a manual operation with the mobile terminal, a behavior of the monitoring target 20 is monitored. The behavior of the monitoring target 20 may be an example of a state of the monitoring target. Also, according to the management system 100 of the present embodiment, image data of an image, in which the QR code 22 has not been photographed, of automatically captured images is not transmitted to the management server 110. Thereby, consumption of network resources is suppressed.

### [Example of Use of Management System 100]

In the present embodiment, for example, the behavior of the moving monitoring target is monitored by using at least two of one or more vehicles 120 or one or more monitoring devices 130 dispersed on the street. For example, a position of the monitoring target is tracked.

In one embodiment, the monitoring target 20 may be a kindergarten child and a student such as an elementary school student, and the personal item 24 of the monitoring target 20 may be at least one of a bag, a backpack, clothes, a hat and shoes. Thereby, even when an unexpected contingency such as a stray child, kidnapping and the like occurs for a student who is a management target or monitoring target of the management system 100, the user of the management system 100 can acquire information, which indicates a location and a time on which the student was last captured or moving history of the monitoring target 20, from the management server 110 by transmitting a search request for searching for a position or moving history of the student to the management server 110 with the communication terminal 140. As the user of the management system 100, a protector of the student, administrative agency and the like are exemplified.

The management server 110 may detect the moving of the monitoring target 20 or the personal item 24. When the moving of the monitoring target 20 or the personal item 24 is detected, the management server 110 may transmit a message, which indicates that the monitoring target 20 or the personal item 24 is moving, to the communication terminal 140 of the user. In the meantime, the monitoring target 20 is not limited to the student. The monitoring target 20 may be an adult or an aged person.

Also, the management target or the monitoring target of the management system 100 is not limited to the monitoring target 20. In another embodiment, the management target or the monitoring target of the management system 100 may be a movable article or a portable article. On the article, the QR code 22 may be arranged. As the article, a moving object such as a vehicle, a drone, a pet animal and the like are exemplified. The article may be an example of the object. The personal item 24 may be an example of the article.

Thereby, the user of the management system 100 can acquire information, which indicates a location and a time on which the article, which is the management target or the monitoring target of the management system 100, was last captured or moving history of the monitoring target 20, in the similar manner as the above-described embodiment. The user may be a possessor or user of the article.

The management server 110 may detect the moving of the movable article or the portable article. When the moving of the movable article or the portable article is detected, the management server 110 may transmit a message, which indicates that the article is moving, to the communication terminal 140 of the user.

In yet another embodiment, the monitoring target 20 may be (i) a participant in an event such as a marathon competition and a street festival or (ii) a user of a facility such as a theme park and an event hall, and the personal item 24 may be an article (for example, zeichen, emblem and the like) that is provided or lent by a sponsor of the event or an operator of the facility. As described above, the management server 110 can collect the image in which the participant in the event or the user of the facility is captured. The management server 110 generates a Web page for distributing or selling the image data of the image, which relates to the participant in the event, the user of the facility or a person registered as a relevant person of the participant or user, to the participant or user. Thereby, the participant in the event or the user of the facility can acquire the image data of the image noticed on the Web page by accessing the Web page with the communication terminal 140.

### [Another Example of Use of Management System 100]

The use of the management system 100 is not limited to the above embodiment. In another embodiment, for example, the outside-of-vehicle imaging unit 122 of one or more moving vehicles 120 can be used as a monitoring camera configured to monitor the monitoring target arranged in a specific position.

In one embodiment, the management target or monitoring target of the management system 100 may be an article fixed in a specific position or a real estate located at a specific point. The personal item 24 may be an example of the article or the real estate. The personal item 24 may be an example of the object. As the article, an advertisement, an objet, a road marker, a plant and the like are exemplified. As the advertisement, a poster, a signboard, a digital signage, a street TV and the like are exemplified. As the real estate, land, constitution of the land, a fixture on the land and the like are exemplified. As the fixture, a house, a building, a facility, a standing tree (for example, street trees) and the like are exemplified. The real estate may also be a road, a rail track or a parking lot. Thereby, the user of the management system 100 can monitor a state of the article or real estate.

In this case, the management server 110 may be configured to detect that a specific event has occurred for the article or real estate. When the occurrence of the event is detected, the management server 110 may transmit a message, which indicates that the event has occurred, to the communication terminal 140 of a the specific user. The specific event may be a preset type of event. The specific event may be an event that has been registered in the management server 110 by a specific user.

For example, in a case in which the monitoring target of the management system 100 is a specific building and the QR code 22 is arranged on the building, image data of images in which the building has been photographed is transmitted from each of one or more vehicles 120 traveling around the building to the management server 110. The user of the management system 100 can acquire the image data of the images, which have been transmitted from each of one or more vehicles 120 to the management server 110, from the management server 110 by transmitting an extraction request for extracting the image in which the building has been captured. Thereby, the user can monitor an appearance of the building. The management server 110 may be configured to determine whether an abnormal situation has occurred in the building. When it is determined that an abnormal situation has occurred in the building, the management server 110 may transmit a message, which indicates that an abnormal situation has occurred in the building, to the communication terminal 140 of the user.

Also, in a case in which the monitoring target of the management system 100 is a specific road marker and the QR code 22 is arranged on the road marker, the user of the management system 100 can check visibility of the road marker by monitoring the road marker. The management server 110 may be configured to determine whether visibility of the road marker satisfies a predetermined condition relating to a degree of visibility. When it is determined that visibility of the road marker satisfies the condition, the management server 110 may transmit a message, which indicates that visibility of the road marker satisfies the condition, to the communication terminal 140 of the user.

Similarly, the management system 100 can monitor a street tree, a parking lot, a road, a rail track, a facility, an advertisement and the like, on which the QR code 22 is arranged. Also, the management system 100 can be used to check a degree of growth of a street tree, to check an empty situation of a parking lot, to check a using situation of a place in which parking or stop is prohibited, to check a congestion situation on a road, to detect occurrence of crime, to detect a dangerous crossing on a road or rail track, to specify a high-crime place, to specify a crossing induction place on a road or rail track, to estimate a degree of guest attraction of a facility or advertisement, and the like.

### [Another Example of Use of Management System 100]

In yet another embodiment, the management system 100 is configured to generate a three-dimensional model of an article fixed in a specific position or a real estate located in a specific spot by using the image data of images captured by the outside-of-vehicle imaging units 122 of one or more moving vehicles 120. As described above, as the article, an objet, a road marker, a plant, an advertisement and the like are exemplified. Also, as the real estate, land, constitution of the land, a fixture on the land and the like are exemplified.

For example, in a case in which the monitoring target of the management system 100 is a specific facility and the QR code 22 is arranged on the facility, image data of images in which the facility has been photographed is transmitted from each of one or more vehicles 120 traveling around the facility to the management server 110. The facility may be a facility which is a landmark in a neighboring region. Each of a plurality of images transmitted to the management server 110 has a different relative positional relation between the vehicle 120 and the facility when each image has been captured. The management server 110 may be configured to estimate a three-dimensional shape of the facility, based on the plurality of images having different relative positional relations between the vehicle 120 and the facility, and to establish a three-dimensional model of the facility. The management server 110 may be configured to generate a map information in which a position of the facility on an electronic map and at least one data of the three-dimensional model of the facility and the image in which the facility has been photographed are associated with each other.

### [Outline of Respective Units of Management System 100]

In the present embodiment, the communication network 10 may be a transmission channel of wired communication, a transmission channel of wireless communication, or a combination of the transmission channel of wireless communication and the transmission channel of wired communication. The communication network 10 may include a radio packet communication network, Internet, a P2P network, a dedicated line, a VPN, a power line communication link, and the like. The communication network 10 may include (i) a mobile communication network such as a mobile phone line network, and (ii) a wireless communication network such as wireless MAN (for example, WiMAX (registered trademark)), wireless LAN (for example, WiFi (registered trademark)), Bluetooth (registered trademark), Zigbee (registered trademark), NFC (Near Field Communication) and the like.

In the QR code 22, predetermined information is encoded in a preset format. The predetermined information includes, for example, at least one of the identification information for identifying the QR code 22 and the identification information for identifying the personal item 24 to which the QR code 22 is provided. The predetermined information may include information indicating contents of processing that is to be executed when the QR code 22 is decoded. The information indicating contents of processing that is to be executed may include at least one of (i) information indicating a type of information to be transmitted to the management server 110, (ii) information indicating an address of the management server 110, and (iii) information indicating a time zone in which the information is to be transmitted to the management server 110.

For example, the predetermined information includes (i) at least one of the identification information for identifying the QR code 22 and the identification information for identifying the personal item 24 to which the QR code 22 is provided, (ii) the information indicating an address of the management server 110, and (iii) a command for causing, when the QR code 22 has been captured and decoded, a computer having decoded the QR code 22 to execute a specific procedure. The command may be a command for causing the computer having decoded the QR code 22 to execute (i) a procedure of acquiring information, which indicates at least one of the location and time on which the QR code 22 has been captured, and (ii) a procedure of transmitting, to the management server 110, information indicating at least one of the identification information for identifying the QR code 22 and the identification information for identifying the personal item 24 having the QR code 22 provided thereto and at least one of the location and time on which the QR code 22 has been captured.

The QR code 22 may be provided to the personal item 24 in such an aspect that the QR code is difficult to be visually recognized with naked eyes. For example, the QR code 22 is constituted of a material capable of reflecting or absorbing non-visible light. The QR code 22 may be constituted of a material capable of reflecting or absorbing at least one of infrared light, near-infrared light, near-ultraviolet light, and ultraviolet light. In this case, the outside-of-vehicle imaging unit 122 or the monitoring camera 132 may be a capturing device capable of receiving the non-visible light and imaging the same. The outside-of-vehicle imaging unit 122 or the monitoring camera 132 may be a capturing device capable of receiving at least one of infrared light, near-infrared light, near-ultraviolet light, and ultraviolet light and imaging the same. The QR code 22 may be constituted of fine dots that are difficult to be visually recognized with naked eyes. The QR code 22 may be hidden by another image.

In the meantime, a method of encoding the information is not limited to the conversion into any code such as a QR code, a barcode and the like. For encoding of the information, known information hiding technology (also referred to as data hiding technology) or any information hiding technology to be developed in future may be used. As the information hiding technology, digital watermarking, steganography and the like are exemplified.

The personal item 24 may be an item that is to be worn on a body of the monitoring target 20 or an item that is to be carried by the monitoring target 20 upon movement. The type, size and material of the personal item 24 are not particularly limited. As the personal item 24, a bag, a hat, clothing, shoes, an accessory and the like are exemplified. The personal item 24 may be an article for child, aged person or pet animal. The personal item 24 may be at least one of a bag, a backpack, a hat, clothing and shoes for a child. Thereby, even when a child gets lost, an aged person walks round or a pet animal runs away, it is possible to easily specify a place in which the child is located or the like and to trace the child or the like by using the management system 100.

In the present embodiment, the management server 110 is configured to collect information about the QR code 22 (also referred to as code information). The code information may include at least one of at least a part of information encoded with the QR code 22 and image data of an image having the QR code 22 photographed therein.

More specifically, the management server 110 is configured to collect information in which the identification information of the QR code 22 and the information, which indicates at least one of the location and time on which the QR code 22 has been captured, are associated with each other. The management server 110 may be configured to collect information in which image data of an image having the QR code 22 photographed therein and information, which indicates at least one of the location and time on which the image has been captured, are associated with each other.

The management server 110 may be configured to generate information, which indicates a position in which the specific monitoring target 20 was last checked, in response to a request from the communication terminal 140, for example. The management server 110 may be configured to generate information, which indicates a moving history of the specific monitoring target 20. The management server 110 may be configured to transmit the information to the communication terminal 140, in response to the request.

In the present embodiment, the vehicle 120 is configured to capture outside images of the vehicle during traveling. The vehicle 120 is configured to transmit image data of an image, which satisfies a specific condition, of the captured images to the management server 110. The vehicle 120 may be configured to analyze the image satisfying the specific condition and to transmit an analysis result to the management server 110. In this case, the vehicle 120 may be configured not to transmit the image data to the management server 110. In the meantime, the vehicle 120 is configured not to transmit image data of an image, which does not satisfy the condition, to the management server 110. The vehicle 120 may be configured to discard the image data of an image, which does not satisfy the condition, at appropriate timing. Thereby, useless consumption of resources of a server and the communication network is suppressed.

As the vehicle 120, an automobile, an automatic two-wheeled vehicle and the like are exemplified. As the automatic two-wheeled vehicle, (i) a motorcycle, (ii) a three-wheeled motorcycle, and (iii) a standing two-wheeled vehicle having a power unit such as a Segway (registered trademark), a scooter having a power unit (registered trademark) and a skateboard having a power unit are exemplified.

In the present embodiment, the outside-of-vehicle imaging unit 122 is mounted on the vehicle 120. The outside-of-vehicle imaging unit 122 is configured to capture outside appearances of the vehicle 120. The vehicle 120 is configured to output image data of a captured image to the image management unit 124.

In the present embodiment, the image management unit 124 is configured to manage the image data of the image captured by the outside-of-vehicle imaging unit 122. In one embodiment, the image management unit 124 is configured to classify images captured by the outside-of-vehicle imaging unit 122 into an image becoming a target of preservation (referred to as preservation target) and an image becoming a target of discard (discard target). The image management unit 124 is configured to transmit, to the management server 110, image information including image data of an image becoming a preservation target, for example. In the meantime, the image management unit 124 is configured to discard image data of an image becoming a discard target without transmitting the same to the management server 110.

In another embodiment, the image management unit 124 is configured to determine whether the QR code 22 is recognized by analyzing at least a part of the image captured by the outside-of-vehicle imaging unit 122. When the QR code 22 is recognized in the image, the image management unit 124 decodes the recognized QR code 22 to acquire the identification information of the QR code 22, the address of the management server 110, a command for transmitting information to the management server 110, and the information indicative of a type of the information to be transmitted to the management server 110, for example. Also, the image management unit 124 may be configured to acquire the information indicative of at least one of the location and time on which the image has been captured, from the vehicle 120 or the outside-of-vehicle imaging unit 122. The image management unit 124 is configured to transmit the information indicated in the QR code 22 to the management server 110. The image management unit 124 will be described in detail later.

The monitoring device 130 is provided on the street, for example. The monitoring camera 132 is configured to capture outside appearances of the monitoring device 130. The monitoring camera 132 is configured to output image data of the captured image to the image management unit 134. The image management unit 134 is configured to manage the image data of the image captured by the monitoring camera 132. The image management unit 134 may have a similar configuration to the image management unit 124.

In the present embodiment, the communication terminal 140 may be configured to transmit and receive the information to and from at least one of the management server 110 and the vehicle 120, and the details thereof are not particularly limited. As the communication terminal 140, a personal computer, a mobile terminal and the like are exemplified. As the mobile terminal, a mobile phone, a smart phone, a PDA, a tablet, a notebook computer or a laptop computer, a wearable computer and the like are exemplified.

The communication terminal 140 may be configured to correspond to one or more communication methods. As the communication method, a mobile communication method, a wireless MAN method, a wireless LAN method, a wireless PAN method and the like are exemplified. As the mobile communication method, a GSM (registered trademark) method, a 3G method, an LTE method, a 4G method, a 5G method and the like are exemplified. As the wireless MAN method, WiMAX (registered trademark) is exemplified. As the wireless LAN method, WiFi (registered trademark) is exemplified. As the wireless PAN method, Bluetooth (registered trademark), Zigbee (registered trademark), NFC (Near Field Communication) and the like are exemplified.

The QR code 22 may be an example of an encoded code. The personal item 24 may be an example of an article. The management system 100 may be an example of an image management device. The management server 110 may be an example of a code information collection device. The vehicle 120 may be an example of a moving object and an image management device. The outside-of-vehicle imaging unit 122 may be an example of an imaging unit. The image management unit 124 may be an example of an image management device.

### [Specific Configuration of Each Unit of Management System 100]

Each unit of the management system 100 may be implemented by hardware, software or hardware and software. Each unit of the management system 100 may be implemented at least partially by a single server or a plurality of servers. Each unit of the management system 100 may be implemented at least partially on a virtual machine or a cloud system. Each unit of the management system 100 may be implemented at least partially by a personal computer or a mobile terminal. As the mobile terminal, a mobile phone, a smart phone, a PDA, a tablet, a notebook computer or a laptop computer, a wearable computer and the like are exemplified. Each unit of the management system 100 may be configured to store information therein by using distributed ledger technology such as block chain or a distributed network.

In a case in which the constitutional elements of the management system 100 are implemented at least partially by software, the constitutional elements implemented by the software may be implemented by activating a program, in which operations of the constitutional elements are described, in an information processing device having a general configuration. The information processing device includes, for example, (i) a data processing device having a processor such as a CPU, a GPU and the like, a ROM, a RAM, a communication interface and the like, (ii) an input device such as a keyboard, a touch panel, a camera, a microphone, various types of sensors, a GPS receiver and the like, (iii) an output device such as a display device, a speaker, a vibration device and the like, and (iv) a storage device (including an external storage device) such as a memory, an HDD and the like.

In the information processing device, the data processing device or the storage device may be configured to store therein a program. The program may be stored in a non-transitory computer-readable recording medium. The program is executed by the processor, thereby causing the information processing device to execute operations described in the program.

The program may be stored in a computer-readable medium such as a CD-ROM, a DVD-ROM, a memory, a hard disk drive and the like or may be stored in a storage device connected to the network. The program may be installed in a computer, which configures at least a part of the management system 100, from the computer-readable medium or the storage device connected to the network. The computer may function as at least a part of each unit of the management system 100 as the program is executed.

The program for causing the computer to function as at least a part of each unit of the management system 100 may have a module in which operations of each unit of the management system 100 are described. The program or module works on the data processing device, the input device, the output device, the storage device and the like to cause the computer to function as each unit of the management system 100 or to cause the computer to execute an information processing method in each unit of the management system 100.

The information processing described in the program functions as a specific means in which software relating to the program and various hardware resources of the management system 100 cooperate with each other as the program is read into the computer. The specific means implements calculation or processing of information in accordance with a using purpose of the computer in the present embodiment, so that the management system 100 is established in accordance with the using purpose.

The program may be a program for causing the computer to function as the management system 100 or the image management unit 124. The program may be a program for causing the computer to execute an information processing method in the management system 100 or the image management unit 124.

In one embodiment, the information processing method may be an image management method. The image management method includes, for example, an image data acquisition step of acquiring image data of an image captured by an imaging unit mounted on a moving object and configured to capture an outside appearance of the moving object, for example. The image management method includes, for example, a determination step of determining whether an encoded code, in which predetermined information is encoded in a preset format, is included in the image by analyzing the image data, for example. The image management method includes, for example, a transmission step of, when it is determined that the encoded code is included in the image, transmitting at least one of at least a part of the predetermined information and the image data to a code information collection device configured to collect information about the encoded code.

### [Outline of Each Unit of Management Server 110]

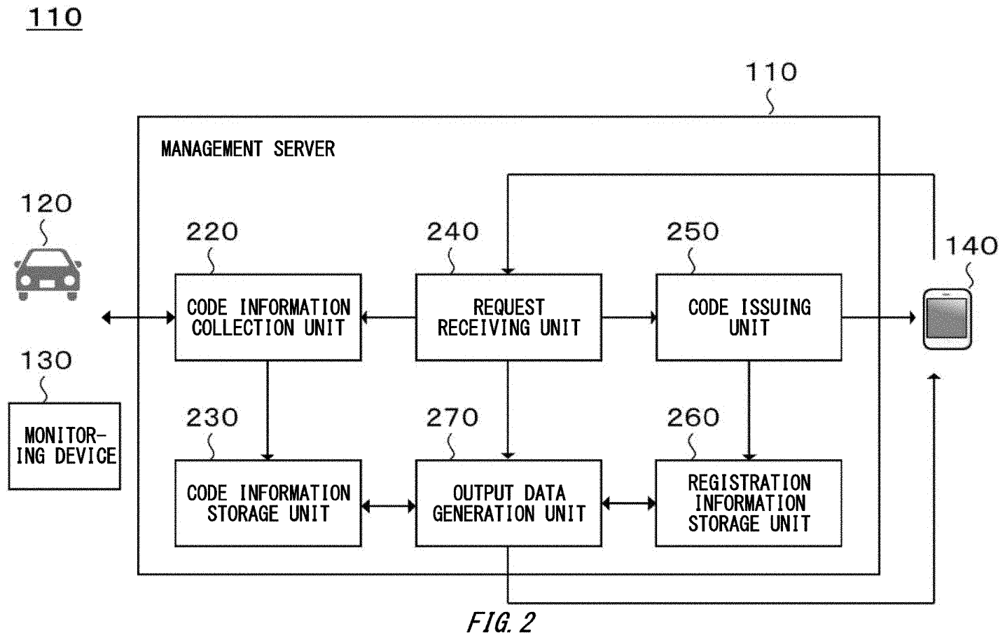

FIG. 2 shows schematically an example of an internal configuration of the management server 110. In the present embodiment, the management server 110 includes a code information collection unit 220, a code information storage unit 230, a request receiving unit 240, a code issuing unit 250, a registration information storage unit 260, and an output data generation unit 270.

In the present embodiment, the code information collection unit 220 is configured to acquire one or more code information from each of one or more image management units 124. The code information collection unit 220 is configured to acquire one or more code information from each of one or more image management units 134. The code information collection unit 220 is configured to store the acquired code information in the code information storage unit 230.

As described above, the code information may include at least one of at least a part of the information encoded with the QR code 22 and the image data of the image having the QR code 22 photographed therein. The code information may include the identification information of the QR code 22, and the information indicative of at least one of the location and time on which the QR code 22 has been captured. The code information may include the image data of the image having the QR code 22 photographed therein, and the information indicative of at least one of the location and time on which the image has been captured.

In the present embodiment, the request receiving unit 240 is configured to acquire various types of requests from the user of the management system 100 through the communication terminal 140. As the requests, (a) a request for issuance of the QR code 22 for a specific monitoring target (for example, the monitoring target 20), and (b) a request for processing of the code information collected by the management server 110 in accordance with a designated purpose or use are exemplified. As the request for processing of the code information collected by the management server 110 in accordance with a designated purpose or use, (i) a request for tracing or monitoring of a behavior or state of the specific monitoring target, (ii) a request for transmission of an image of the specific monitoring target, (iii) a request for establishment of a three-dimensional model of the specific monitoring target, and (iv) a request for generation of map information in which a location of the specific monitoring target and at least one data of a three-dimensional model of the monitoring target and an image having the monitoring target photographed therein are associated with each other are exemplified.

The request for issuance of the QR code 22 for a specific monitoring target includes, for example, information indicative of at least one of (i) information for specifying the monitoring target, (ii) information for specifying a client having requested issuance of the QR code 22, (iii) a type or material of the QR code 22, (iv) a size of the QR code 22, (v) a shape, a design and a color of the QR code 22, and (vi) a method of providing the QR code 22. The request for processing of the code information collected by the management server 110 in accordance with a designated purpose or use may include, for example, at least one of (i) information for specifying the monitoring target, (ii) identification information of the QR code 22 provided to the monitoring target, (iii) information for specifying a client having requested processing of the code information, (iv) an address of the client, (v) information indicating the purpose or use.

The client may be the user of the communication terminal 140. As the information for specifying the client, (i) a name, appellation or pseudonym of the client, (ii) a combination of a name, appellation or pseudonym of the client and an address or residence of the client, (iii) a combination of a name, appellation or pseudonym of the client and authentication information of the client, (iv) an account allotted to the client by an operator of any service, and (iv) a combination of an account allotted to the client by an operator of any service and authentication information of the account are exemplified.

As the authentication information, a pass phrase, a biological information and the like are exemplified. As the service, a distribution service, a logistics service, a transportation service, a communication service, a WEB service, an SNS and the like are exemplified. The account allotted to the user of the service by the operator of the communication service may be a telephone number or a mail address. The account allotted to the user of the service by the operator of the Web service may be a mail address. As the address of the client, (i) a mail address allotted to the client, and (ii) an account of the WEB service or SNS allotted to the client are exemplified.

More specifically, for example, the request for tracing or monitoring of a behavior or state of the specific monitoring target 20 includes (i) the information for specifying the monitoring target 20, (ii) the identification information of the QR code 22 provided to the personal item 24, (iii) information for specifying a client having requested tracing or monitoring of the monitoring target 20, and (iv) information indicating at least one of addresses of the client. The client may be a protector of the monitoring target 20 or an administrative agency.

For example, when the user of the management system 100 requests issuance of the QR code 22 for the specific monitoring target, the user transmits the request to the management server 110 by using the communication terminal 140. When the request receiving unit 240 receives the request, it transfers the request to the code issuing unit 250. In the meantime, when the user of the management system 100 requests processing of the code information about the specific monitoring target for a specific purpose, the user transmits the request to the management server 110 by using the communication terminal 140. When the request receiving unit 240 receives the request, it transfers the request to the output data generation unit 270.

When the user of the management system 100 requests processing of the code information about the specific monitoring target, there is a possibility that some of the code information is temporarily preserved in the vehicle 120 or the monitoring device 130 and is not yet transmitted to the management server 110, depending on a timing at which the request receiving unit 240 receives the request. Therefore, when the request receiving unit 240 receives the request for processing of the code information about the specific monitoring target, the request receiving unit 240 may transfer the request to the code information collection unit 220.

In this case, the code information collection unit 220 is configured to request one or more image management units 124 and one or more image management unit 134 to transmit the not-yet-transmitted code information to the management server 110. At this point, if all of the image management units 124 and the image management units 134 response to the request at the same time, processing capability of the management server 110 may become insufficient.

Therefore, in one embodiment, the code information collection unit 220 is configured to specify a location and a time on which the specific monitoring target was last checked. Then, the code information collection unit 220 is configured to transmit a request for transmitting the not-yet-transmitted code information to the management server 110 to the image management unit 124 of the vehicle 120 or the image management unit 134 of the monitoring device 130, which currently exists in a specific range including the location. When the vehicle 120 or the monitoring device 130 currently exists in the specific range, the code information collection unit 220 may request the vehicle 120 or the monitoring device 130 to response to the request.

Thereby, a large amount of the code information is suppressed from being transmitted to the management server 110 in a short time. The specific range is determined, based on at least one of (i) a type of a means of transportation that can be used in the vicinity of the location in which the specific monitoring target was last checked, and (ii) a moving speed of the monitoring target in the time on which the specific monitoring target was last checked, for example.

In another embodiment, the code information collection unit 220 is configured to generate information indicating the location and time on which the specific monitoring target was last checked. The code information collection unit 220 is configured to transmit the information to one or more image management units 124 and one or more image management units 134, together with the request for transmitting the not-yet-transmitted code information to the management server 110. When the vehicle 120 or the monitoring device 130 exists in the vicinity of the location in which the specific monitoring target was last checked in the time on which the specific monitoring target was last checked, the code information collection unit 220 may request the vehicle or the monitoring device to respond to the request. Thereby, a large amount of the code information is suppressed from being transmitted to the management server 110 in a short time.

In the present embodiment, the code issuing unit 250 is configured to acquire the request for issuance of the QR code 22 from the request receiving unit 240. The code issuing unit 250 is configured to issue a new QR code 22, in response to the request. The code issuing unit 250 is configured to transmit or deliver the issued QR code 22 to the client of the request. The code issuing unit 250 may be configured to associate information, which is included in the request for issuance of the QR code 22, and identification information of the newly issued QR code 22 and to store the same in the registration information storage unit 260. For example, the registration information storage unit 260 may be configured to associate and store the identification information of the QR code 22 and at least one of information for specifying the monitoring target to which the QR code 22 is to be provided, information for specifying the client having requested issuance of the QR code 22 and an address of the client, for each of one or more QR codes 22.

In the present embodiment, the output data generation unit 270 is configured to acquire a request for processing of the code information collected by the management server 110 from the request receiving unit 240, in accordance with a designated purpose or use. The output data generation unit 270 is configured to execute processing designated by the request. For example, the output data generation unit 270 is configured to extract one or more code information corresponding to contents of the request with reference to the code information storage unit 230. The output data generation unit 270 is configured to generate data corresponding to the request (also referred to as output data), based on at least a part of the extracted code information. The output data generation unit 270 is configured to transmit the output data to the address of the client of the request, in response to the request.

More specifically, for example, the output data generation unit 270 is configured to acquire a request for tracing of a behavior of the specific monitoring target 20 from the request receiving unit 240. The output data generation unit 270 is configured to generate a moving history of the monitoring target 20 with reference to the information stored in the code information storage unit 230 and the registration information storage unit 260, in accordance with the request. The output data generation unit 270 is configured to transmit information, which indicates the generated moving history, to the communication terminal 140 having transmitted the request, in response to the request.

### [Outline of Each Unit of Vehicle 120]

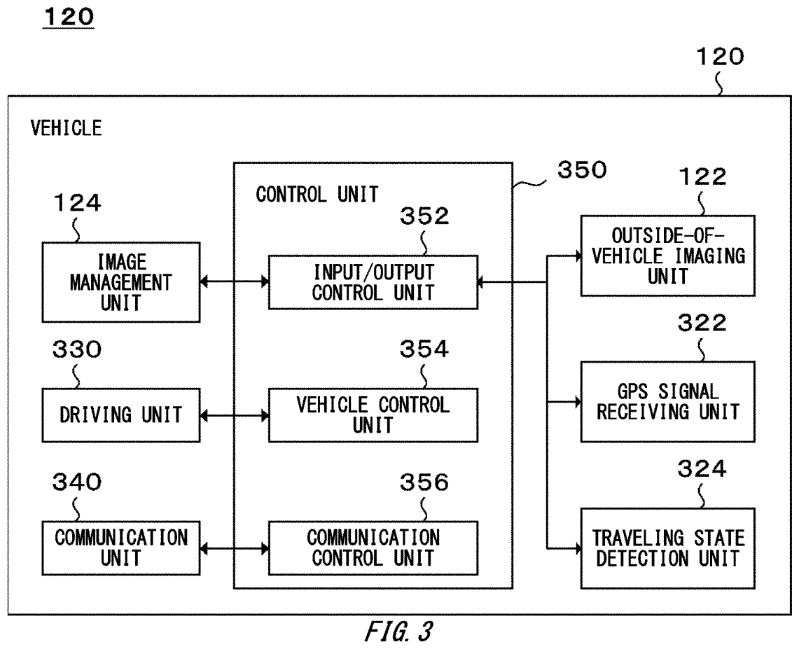

FIG. 3 shows schematically an example of an internal configuration of the vehicle 120. In the present embodiment, the vehicle 120 includes an outside-of-vehicle imaging unit 122, an image management unit 124, a GPS signal receiving unit 322, a traveling state detection unit 324, a driving unit 330, a communication unit 340, and a control unit 350. In the present embodiment, the control unit 350 includes an input/output control unit 352, a vehicle control unit 354, and a communication control unit 356.

In the present embodiment, the GPS signal receiving unit 322 is configured to receive a GPS signal. The GPS signal receiving unit 322 may be configured to generate position information indicative of a position of the vehicle 120, based on the received GPS signal.

In the present embodiment, the traveling state detection unit 324 is configured to detect a traveling state of the vehicle 120, based on an output of any internal sensor or any external sensor arranged on the vehicle 120. As the traveling state of the vehicle 120, a speed, an acceleration, an inclination, vibration, noise, an operating situation of the driving unit 330, an occurrence situation of abnormality, a current position, a moving path, a temperature of exterior air, a humidity of exterior air, a pressure of exterior air, a temperature of internal space, a humidity of internal space, a pressure of internal space, a position relative to a surrounding object, a speed relative to a surrounding object, whether or not traffic jam or a degree of traffic jam, a continuous driving time period, whether or not abrupt acceleration or a frequency of abrupt acceleration, whether or not abrupt deceleration or a frequency of abrupt deceleration, and the like are exemplified. The traveling state of the vehicle 120 may be an example of a moving state of a moving object.

In the present embodiment, the driving unit 330 is configured to drive the vehicle 120. The driving unit 330 may be configured to drive the vehicle 120, in response to a command from the control unit 350. The driving unit 330 may be configured to generate power by an internal combustion engine or by an electric motor. The driving unit 330 may include at least one of an automatic safety device and an automatic driving device. The driving unit 330 may include a variety of ancillary facilities as well as a facility directly necessary to drive the vehicle 120. As the ancillary facilities, a security device, a seat adjusting device, a lock managing device, a window opening and closing device, an illumination device, an air-conditioning device, a navigation device, a sound device, a video device and the like are exemplified.

In the present embodiment, the communication unit 340 is configured to transmit and receive information between the vehicle 120 and the management server 110 via the communication network 10. The communication unit 340 may be configured to correspond to one or more communication methods.

In the present embodiment, the control unit 350 is configured to control each unit of the vehicle 120. For example, the control unit 350 is configured to receive an input of at least one of image data of an image captured by the outside-of-vehicle imaging unit 122, the position information generated by the GPS signal receiving unit 322, and the information indicative of the traveling state detected by the traveling state detection unit 324. Also, the control unit 350 is configured to transfer the input image data to the image management unit 124.

In the present embodiment, the input/output control unit 352 is configured to control input and output of the information in the vehicle 120. In the present embodiment, the input/output control unit 352 is configured to control the outside-of-vehicle imaging unit 122, the image management unit 124, the GPS signal receiving unit 322, and the traveling state detection unit 324. The input/output control unit 352 may be configured to control at least one (not shown) of other types of input devices and output devices.

In the present embodiment, the vehicle control unit 354 is configured to control operations of the vehicle 120. The vehicle control unit 354 may be configured to control operations of the driving unit 330. For example, the vehicle control unit 354 is configured to acquire the information output from the traveling state detection unit 324. The vehicle control unit 354 is configured to control operations of the driving unit 330, based on the information output from the traveling state detection unit 324.

In the present embodiment, the communication control unit 356 is configured to control communication between the vehicle 120 and an external device. The communication control unit 356 may be configured to control operations of the communication unit 340. The communication control unit 356 may be a communication interface. The communication control unit 356 may be configured to correspond to one or more communication methods. The communication control unit 356 may be configured to detect or monitor a communication state between the management server 110 and the vehicle 120. The communication control unit 356 may be configured to generate communication information indicative of the communication state, based on a result of the detection or monitoring.

As the communication information, information about whether communication is possible, a radio wave condition, a communication quality, a type of the communication method, a type of communication carrier and the like is exemplified. As the radio wave condition, a radio wave receiving level, a radio field intensity, RSCP (Received Signal Code Power), CID (Cell ID) and the like are exemplified. As the communication quality, communication speed, throughput of data communication, latency of data communication, and the like are exemplified.

### [Outline of Each Unit of Image Management Unit 124]

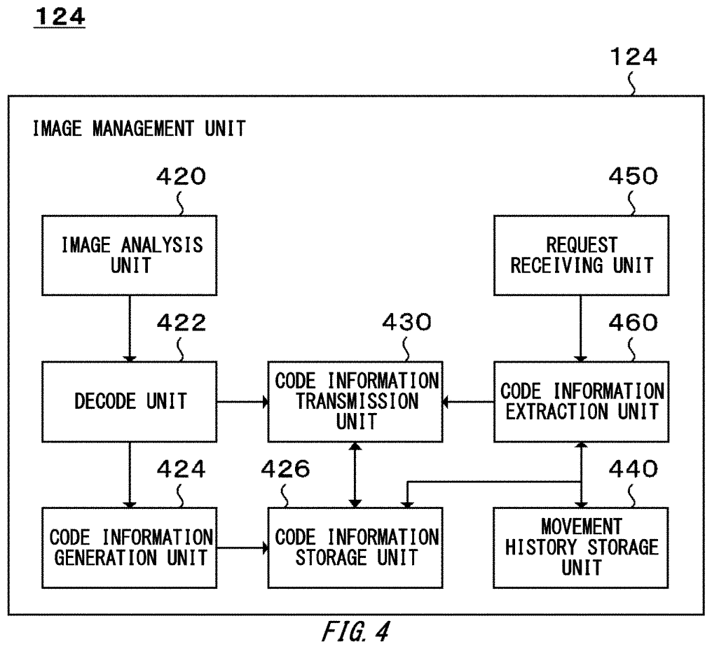

FIG. 4 shows schematically an example of an internal configuration of the image management unit 124. In the meantime, the image management unit 134 may also have a similar internal configuration to the image management unit 124. In the present embodiment, the image management unit 124 includes an image analysis unit 420, a decode unit 422, a code information generation unit 424, a code information storage unit 426, a code information transmission unit 430, a moving history storage unit 440, a request receiving unit 450, and a code information extraction unit 460.

The image analysis unit 420 may be an example of an image data acquisition unit and a determination unit. The code information generation unit 424 may be an example of an ancillary information acquisition unit. The code information transmission unit 430 may be an example of a transmission unit.

In the present embodiment, the image analysis unit 420 is configured to acquire the image data of the image captured by the outside-of-vehicle imaging unit 122. The image analysis unit 420 may be configured to analyze the image data of the image to determine whether the QR code 22 is included in the image. When the QR code 22 is included in the image, the image analysis unit 420 outputs the image or the image data of the QR code 22 included in the image to the decode unit 422, for example. The image analysis unit 420 may be configured to output (i) the identification information for identifying the image, and (ii) the image or the image data of the QR code 22 included in the image to the decode unit 422. On the other hand, when the QR code 22 is not included in the image, the image analysis unit 420 discards the image data of the image at appropriate timing, for example.

In the present embodiment, the decode unit 422 is configured to acquire the image in which the QR code 22 is included or the image data of the QR code 22 from the image analysis unit 420. The decode unit 422 is configured to decode the QR code 22 to acquire the information encoded and stored in the QR code 22. As described above, the information may include a command that is executed by the computer having decoded the QR code 22 and is configured to cause the computer to execute specific processing.

The decode unit 422 may be configured to execute a variety of processing, in accordance with the command encoded and stored in the QR code 22. For example, the decode unit 422 is configured to output the identification information of the QR code 22 encoded and stored in the QR code 22 to the code information generation unit 424 to thereby execute the generation processing of the code information. Also, the decode unit 422 is configured to output, to the code information transmission unit 430, a command for executing a procedure of transmitting (i) the identification information of the QR code 22 and (ii) code information corresponding to the identification information, as the code information generated by the code information generation unit 424, to the management server 110.

In the present embodiment, the code information generation unit 424 is configured to generate the code information. As described above, the code information includes at least one of at least a part of the information encoded with the QR code 22 and the image data of the image having the QR code 22 photographed therein. For example, the code information generation unit 424 is configured to acquire the identification information of the QR code 22 from the decode unit 422. Also, the code information generation unit 424 is configured to acquire the identification information of the image having the QR code 22 included therein from the decode unit 422. The code information generation unit 424 is configured to acquire information (also referred to as ancillary information), which indicates at least one of the location and time on which the image has been captured, by using the identification information of the image as a key. The ancillary information may further include identification information for identifying the outside-of-vehicle imaging unit 122 having captured the image or identification information for identifying the vehicle 120 having the outside-of-vehicle imaging unit 122 mounted thereto.

The code information generation unit 424 is configured to generate code information including the identification information of the QR code 22 and the ancillary information, for example. The code information may be information in which the identification information of the QR code 22 and the ancillary information are associated with each other. The code information generation unit 424 may be configured to store the generated code information in the code information storage unit 426.

In the present embodiment, when it is determined that the QR code 22 is included in the image, the code information transmission unit 430 transmits the code information generated by the code information generation unit 424 to the management server 110. The code information transmission unit 430 may be configured to transmit the code information stored in the code information storage unit 426 to the management server 110 at any timing or at timing designated by the management server 110 or the user.

In one embodiment, information (in the present embodiment, an address of the management server 110) indicative of a transmission destination of the code information may be preset. In this case, the code information transmission unit 430 may be configured to acquire information indicative of an address of the management server 110 by receiving a message, which includes the information indicative of the address of the management server 110, from the management server 110, for example.

In another embodiment, the information (in the present embodiment, an address of the management server 110) indicative of a transmission destination of the code information may be encoded by the QR code 22. In this case, the code information transmission unit 430 is configured to acquire the information indicative of a transmission destination of the code information from the decode unit 422.

In yet another embodiment, the code information transmission unit 430 is configured to determine a transmission destination corresponding to the QR code 22 decoded by the decode unit 422 with reference to a database, in which the identification information of the QR code 22 and the information indicative of a transmission destination of the code information are stored with being associated with each other, for each of one or more QR codes 22. The database may be stored in the code information storage unit 426 or a storage device connected to the communication network 10.

For example, the code information transmission unit 430 is configured to transmit, to the management server 110, the code information in which (i) at least one of the identification information of the QR code 22 and the image data of the image in which the QR code 22 is included and (ii) the ancillary information of the image in which the QR code 22 is included are associated with each other. The code information transmission unit 430 may be configured to transmit the identification information of the QR code 22 and the image data of the image in which the QR code 22 is included to the management server 110.

In the present embodiment, the request receiving unit 450 is configured to acquire a request signal for transmission of the not-yet-transmitted code information to the management server 110, from the code information collection unit 220 of the management server 110. As described above, the signal includes the information, which indicates the condition for determining the image management unit 124 or the image management unit 134 required to make a response. The code information extraction unit 460 is configured to output the information indicative of contents of the request and the information indicative of the condition to the code information extraction unit 460.

In the present embodiment, the code information extraction unit 460 is configured to acquire, from the request receiving unit 450, a request for transmission of the not-yet-transmitted code information to the management server 110 and the information, which indicates the condition for determining the image management unit 124 required to make a response. The request receiving unit 450 is configured to extract information, which indicates the location of the vehicle 120 at the current or past specific point in time, with reference to the information indicative of the moving history of the vehicle 120 stored in the moving history storage unit 440.

The code information extraction unit 460 is configured to determine whether the location of the vehicle 120 at the current or past specific point in time satisfies the condition included in the request. When it is determined that the location of the vehicle 120 at the current or past specific point in time satisfies the condition included in the request, the code information extraction unit 460 specifies the not-yet-transmitted code information. The code information extraction unit 460 is configured to transmit information indicative of the specified code information to the code information transmission unit 430 for initiating processing for transmitting the code information to the management server 110. Thereby, the not-yet-transmitted code information stored in the image management unit 124 is transmitted to the management server 110, based on the request from the management server 110.

In the present embodiment, the image management unit 124 has been described with reference to the example in which when the QR code 22 is included in the image captured by the outside-of-vehicle imaging unit 122, (i) the image analysis unit 420 outputs the image or the image data of the QR code 22 included in the image to the decode unit 422, and (ii) the code information transmission unit 430 transmits the code information generated by the code information generation unit 424 to the management server 110. However, the image management unit 124 is not limited to the present embodiment.

In another embodiment, when the QR code 22 is included in the image captured by the outside-of-vehicle imaging unit 122, the image analysis unit 420 may output the image or the image data of the QR code 22 included in the image to the code information transmission unit 430. In this case, the code information transmission unit 430 is configured to acquire the information (in the present embodiment, an address of the management server 110) indicative of a transmission destination of the image data, in the similar procedure to the above embodiment. Also, the code information transmission unit 430 is configured to transmit the image data to the transmission destination. The code information transmission unit 430 may be configured to associate the image data and the ancillary information relating to the image each other and to transmit the same to the transmission destination.

[Application Example of Monitoring on Behavior or State of Monitoring Target]

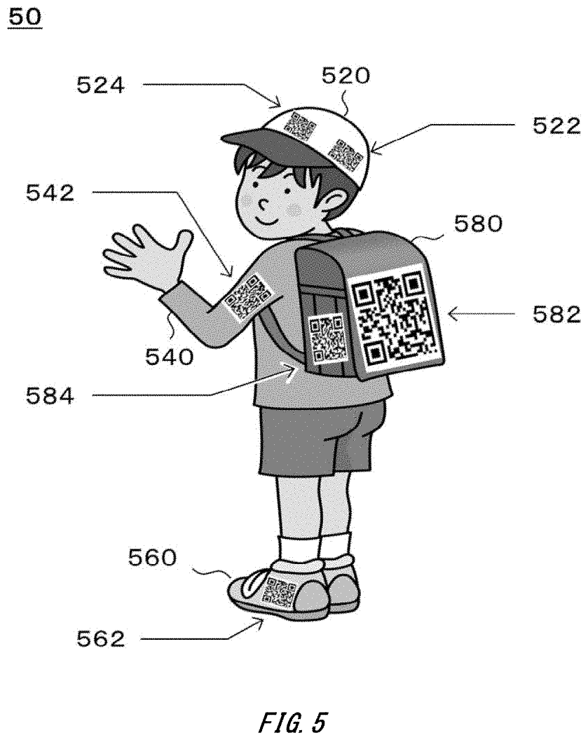

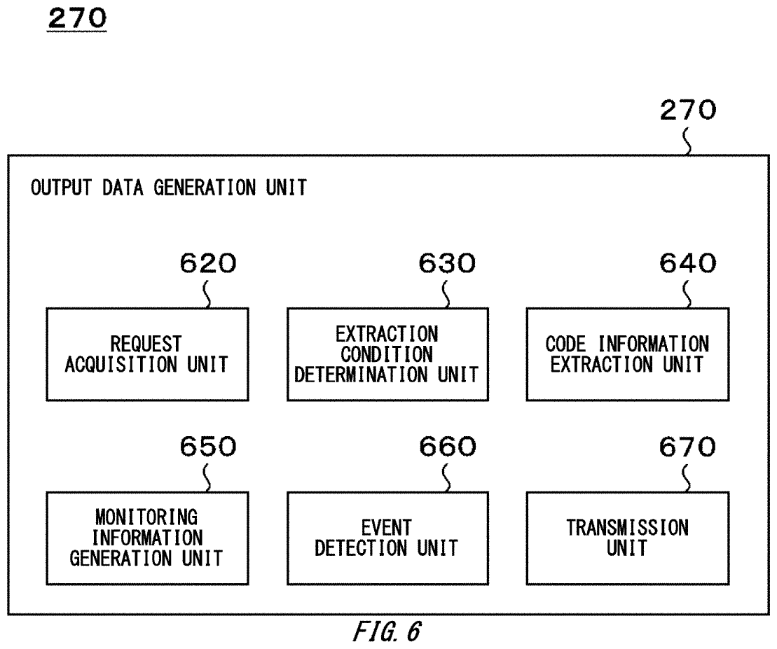

The management system 100 is described in detail with reference to FIGS. 5 and 6, taking as an example a case in which the management system 100 is used to provide a service for monitoring a behavior or state of the monitoring target. In the present embodiment, the monitoring target of the management system 100 is a student 50. FIG. 5 shows schematically an example of an outer appearance of the student 50. In the present embodiment, the student 50 wears a hat 520, clothes 540 and shoes 560. Also, the student 50 carries a backpack 580.

In the present embodiment, a QR code 522 and a QR code 524 are arranged on the hat 520. A QR code 542 is arranged on the clothes 540. A QR code 562 is arranged on the shoes 560. A QR code 582 and a QR code 584 are arranged on the backpack 580. The QR code 522, the QR code 524, the QR code 542, the QR code 562, the QR code 582 and the QR code 584 may have similar configurations to the QR code 22.

The hat 520, the clothes 540, the shoes 560 and the backpack 580 may be examples of the article. The QR code 522, the QR code 524, the QR code 542, the QR code 562, the QR code 582 and the QR code 584 may be examples of the encoded code.

FIG. 6 shows schematically an example of an internal configuration of the output data generation unit 270. In the present embodiment, the output data generation unit 270 includes a request acquisition unit 620, an extraction condition determination unit 630, a code information extraction unit 640, a monitoring information generation unit 650, an event detection unit 660, and a transmission unit 670.

In the present embodiment, the request acquisition unit 620 is configured to acquire a request for processing of the code information collected by the management server 110, from the request receiving unit 240. For example, the request acquisition unit 620 is configured to acquire a request indicative of initiation of processing for monitoring a behavior of the student 50, as a request from a protector of the student 50. As described above, the request may include at least one of (i) the information for specifying the monitoring target, (ii) the identification information of the QR code 22 provided to the monitoring target, (iii) the information for specifying a client having requested processing of the code information, (iv) an address of the client, (v) information indicating the purpose or use.

The request acquisition unit 620 may be configured to analyze the request to output the information for specifying the monitoring target or the identification information of the QR code 22 provided to the monitoring target to the extraction condition determination unit 630. The request acquisition unit 620 may be configured to output information, which indicates contents of processing to be executed, to the extraction condition determination unit 630. Also, the request acquisition unit 620 may be configured to output information, which indicates an address of the client of the request, to the transmission unit 670.

In the present embodiment, the extraction condition determination unit 630 is configured to determine a condition for the code information extraction unit 640 extracting code information, which is necessary to execute processing indicated by the request, from a plurality of code information stored in the code information storage unit 230. The extraction condition determination unit 630 is configured to output the determined condition to the code information extraction unit 640.

In the present embodiment, the extraction condition determination unit 630 is configured to determine a condition relating to code information necessary to monitor a behavior of the student 50. The condition may be code information relating to at least one of one or more QR codes arranged on the personal items of the student 50. The extraction condition determination unit 630 may be configured to specify one or more QR codes arranged on the personal items of the student 50 with reference to the database in which the identification information of the monitoring target and the identification information of the QR codes to be provided to the monitoring target are stored with being associated with each other. The condition may include a condition relating to a tracing time period.

In the present embodiment, the code information extraction unit 640 is configured to extract code information, which meets the condition determined by the extraction condition determination unit 630, from the plurality of code information stored in the code information storage unit 230. The code information extraction unit 640 is configured to output the extracted code information or a part of the code information to the monitoring information generation unit 650.

In the present embodiment, the monitoring information generation unit 650 is configured to generate information (also referred to as monitoring information) indicative of a monitoring result of the behavior of the student 50, based on one or more code information extracted by the code information extraction unit 640. The monitoring information generation unit 650 may be configured to output the generated monitoring information to the transmission unit 670.

As described above, one or more code information transmitted from each of one or more vehicles 120 traveling on the street to the management server 110 is stored in the code information storage unit 230. Also, one or more code information transmitted from each of one or more monitoring devices 130 provided on the street to the management server 110 is stored in the code information storage unit 230. Also, the code information may include the image data of the image in which the student 50 is captured, and the information indicative of at least one of the location and time on which the image has been captured.

Therefore, the monitoring information generation unit 650 is configured to generate information indicative of a moving history of the student 50 for a specific time period (for example, the tracing time period), as the monitoring information. The monitoring information generation unit 650 may be configured to generate information indicative of the location and time on which the student 50 was last captured, as the monitoring information. Thereby, the management system 100 can trace or monitor the behavior of the student 50.

The monitoring information generation unit 650 may be configured to generate information in which information indicative of a moving history of the student 50 for the specific time period and image data of an image in which the student 50 has been captured at any point in time for the specific time period are associated with each other, as the monitoring information. The monitoring information generation unit 650 may be configured to generate information in which the information indicative of the location and time on which the student 50 was last captured and image data of an image in which the student 50 was last captured are associated with each other, as the monitoring information. Thereby, the management system 100 can trace or monitor the state of the student 50.

In the present embodiment, the event detection unit 660 is configured to detect occurrence of a specific event with respect to a behavior or state of the monitoring target. For example, the event detection unit 660 is configured to detect variation in position of the student 50. The event detection unit 660 may be configured to detect an increase or decrease in personal items of the student 50. When occurrence of the event is detected, the event detection unit 660 may generate a message for notifying a type or contents of the detected event to a client of the request. The message may include information indicative of at least one of a position and a time on which the event has been detected. The event detection unit 660 may be configured to output the generated message to the transmission unit 670.

In the present embodiment, the transmission unit 670 is configured to transmit the monitoring information generated by the monitoring information generation unit 650 to a client of the request (in the present embodiment, a protector of the student 50). The transmission unit 670 may be configured to transmit the message generated by the event detection unit 660 to the client of the request.

In the present embodiment, the management system 100 has been described in detail with reference to the example in which the monitoring target of the management system 100 is moving. However, the management system 100 is not limited to the present embodiment. In another embodiment, the monitoring target of the management system 100 may be an article fixed in a specific position or a real estate located at a specific point. Thereby, the management system 100 can establish a pseudo fixed-point observation system by using the outside-of-vehicle imaging unit 122 mounted on one or more moving vehicles 120.

### [Application Example Relating to Distribution or Sale of Image]

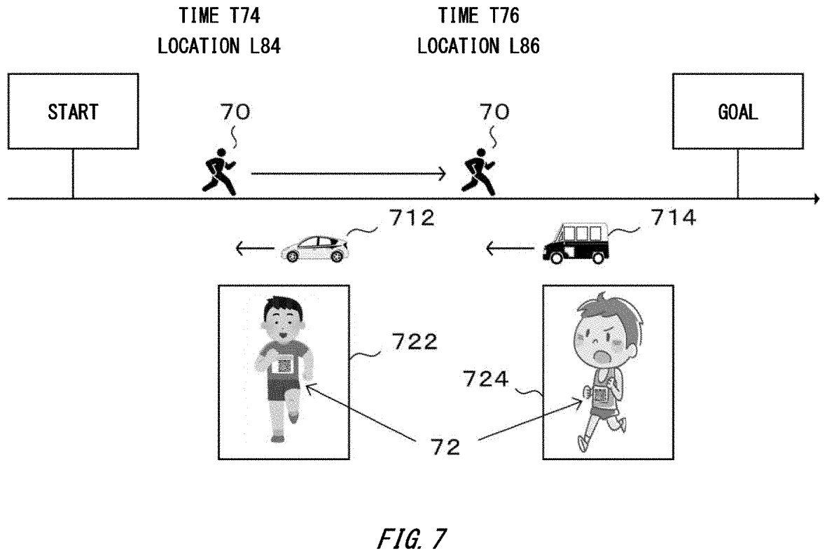

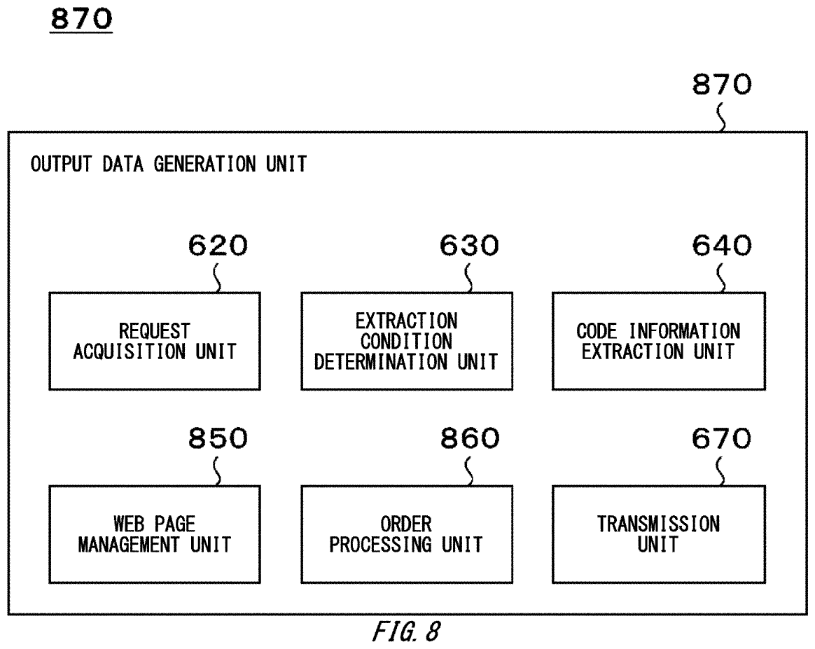

The management system 100 is described in detail with reference to FIGS. 7 and 8, taking as an example a case in which the management system 100 is used to provide a service of distributing or selling image data of an image in which the specific monitoring target has been captured to a relevant person of the monitoring target or the monitoring target. In the present embodiment, the monitoring target of the management system 100 is a runner 70 taking part in a marathon competition. Also, the runner 70 wears a zeichen on which a QR code 72 is arranged.

FIG. 7 shows schematically an example of an acquisition method of an image of the runner 70. In the present embodiment, the runner 70 goes by a vehicle 712 when running at a location L84 at time T74. At this time, the outside-of-vehicle imaging unit mounted on the vehicle 712 captures the runner 70. The vehicle 712 transmits image data of an image 722 in which the runner 70 has been captured at the location L84 to the management server 110. The vehicle 712 may transmit code information about the QR code 72 to the management server 110.

Likewise, the runner 70 goes by a vehicle 714 when running at a location L86 at time T76. At this time, the outside-of-vehicle imaging unit mounted on the vehicle 714 captures the runner 70. The vehicle 714 transmits image data of an image 724 in which the runner 70 has been captured at the location L86 to the management server 110. The vehicle 714 may transmit the code information about the QR code 72 to the management server 110.

The QR code 72 may have a similar configuration to the QR code 22. The vehicle 712 and the vehicle 714 may have similar configurations to the vehicle 120. The zeichen may be an example of the article. The QR code 72 may be an example of the encoded code. The vehicle 712 and the vehicle 714 may be examples of the moving object.

FIG. 8 shows schematically an example of an internal configuration of an output data generation unit 870. The output data generation unit 870 may be another example of the output data generation unit 270. In the present embodiment, the output data generation unit 870 includes a request acquisition unit 620, an extraction condition determination unit 630, a code information extraction unit 640, a WEB page management unit 850, an order processing unit 860, and a transmission unit 670. In the present embodiment, the members having similar configurations to the respective units of the output data generation unit 270 described with reference to FIG. 6 are denoted with the same reference signs as FIG. 6, and the detailed descriptions thereof may be omitted.

In the present embodiment, the request acquisition unit 620 is configured to acquire a request for generation of a WEB page for distributing or selling an image, in which each runner has been captured during the marathon competition, as a request from each of one or more runners 70. The request acquisition unit 620 may be configured to analyze the request to output information for specifying the runner 70 or identification information of the QR code 72 provided to the runner 70 to the extraction condition determination unit 630. The request acquisition unit 620 may be configured to output information, which indicates contents of processing to be executed, to the extraction condition determination unit 630. Also, the request acquisition unit 620 may be configured to output information, which indicates an address of a client of the request, to the transmission unit 670.

In the present embodiment, the extraction condition determination unit 630 is configured to determine a condition relating to code information necessary to extract the image in which the runner 70 has been captured during the marathon competition. The condition may include a condition of the code information about the QR code 72 arranged on the zeichen distributed to the runner 70, and a condition of the code information about the image captured during the marathon competition.

In the present embodiment, the code information extraction unit 640 is configured to extract image data included in the code information, which meets the condition determined by the extraction condition determination unit 630, with reference to the code information storage unit 230. The code information extraction unit 640 is configured to output the extracted image data to the WEB page management unit 850.

In the present embodiment, the WEB page management unit 850 is configured to manage the WEB page for distributing or selling the image data of the image in which the runner 70 has been captured. For example, the WEB page management unit 850 is configured to generate a WEB page for presenting one or more images in which the respective runners are captured by using the image data extracted by the code information extraction unit 640, for each of one or more runners 70. The WEB page may include an element for selecting an image that is desired to be distributed or bought and an element for deciding distribution or buying of the selected image. The WEB page may include an element for determining a method of delivering the image data. Each runner or relevant person thereof can select an image to be distributed or bought and acquire image data of the selected image by accessing the WEB page with the communication terminal 140.

In the present embodiment, the order processing unit 860 is configured to execute processing for distributing or selling the image data of the image selected by each runner or relevant person thereof to the runner or relevant person. For example, the order processing unit 860 is configured to execute processing relating to delivery or distribution of the image data. The order processing unit 860 may be configured to execute settlement processing relating to delivery or distribution of the image data. In the present embodiment, the transmission unit 670 is configured to transmit the image data of the image selected by each runner or relevant person thereof to the runner or relevant person.

### [Application Example Relating to Generation of Map Information]

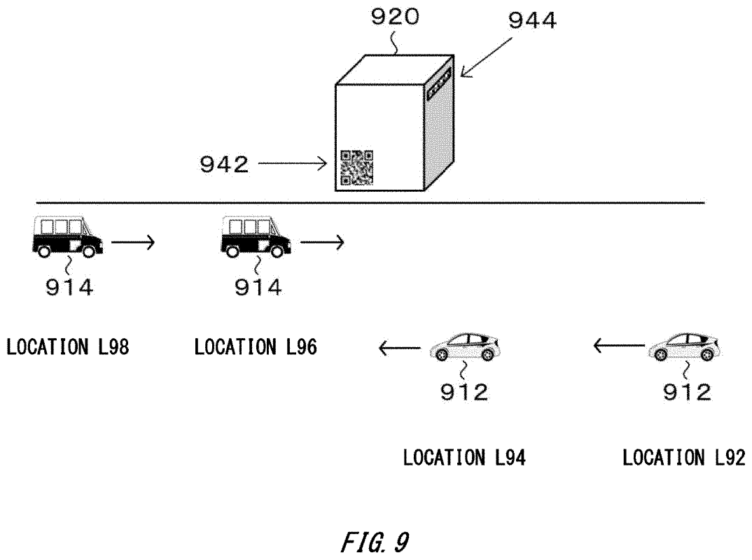

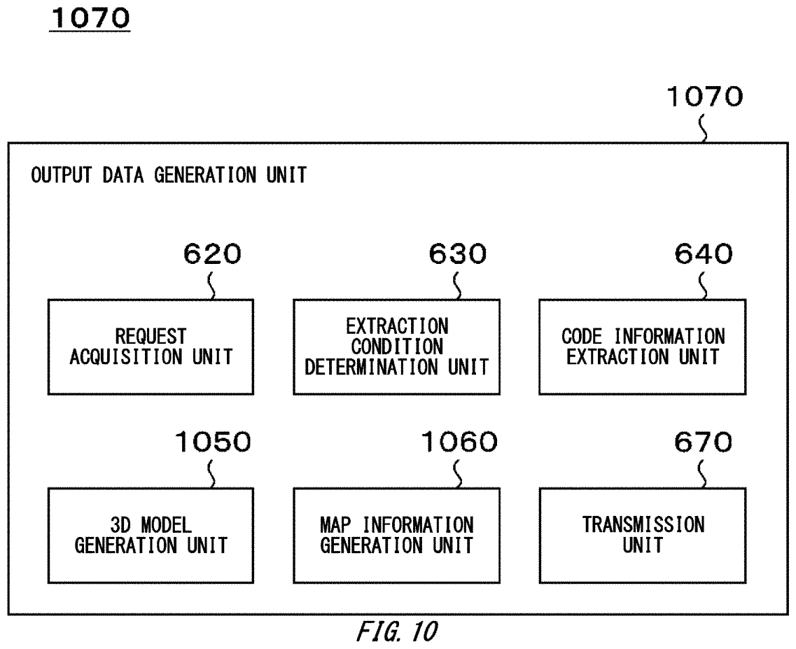

The management system 100 is described in detail with reference to FIGS. 9 and 10, taking as an example a case in which the management system 100 is used to provide a service of generating a three-dimensional model of the monitoring target, based on an image in which a specific monitoring target has been captured. In the present embodiment, the monitoring target of the management system 100 is a facility 920. Also, a QR code 942 and a QR code 944 are arranged on outer walls of the facility 920.

In the present embodiment, the QR code 942 and the QR code 944 are arranged on surfaces, which face toward different orientations, of a plurality of surfaces of the facility 920. In the meantime, the number of the QR codes to be arranged on the facility 920 is not limited to the present embodiment. On the facility 920, a single QR code may be arranged. Alternatively, a plurality of QR codes may be arranged in different positions on a single surface of the facility 920.

FIG. 9 shows schematically an example of an acquisition method of an image of the facility 920. In the present embodiment, the outside-of-vehicle imaging unit mounted on a vehicle 912 under traveling captures the facility 920 at a location L92 and at a location L94. The vehicle 912 transmits image data of images in which the facility 920 has been captured from the location L92 and location L94 to the management server 110. The vehicle 912 may transmit code information about the QR code 942 and the QR code 944 to the management server 110.

Also, the outside-of-vehicle imaging unit mounted on a vehicle 914 under traveling captures the facility 920 at a location L96 and at a location L98. The vehicle 914 transmits image data of images in which the facility 920 has been captured from the location L96 and location L98 to the management server 110. The vehicle 914 may transmit the code information about the QR code 942 and the QR code 944 to the management server 110.

The vehicle 912 and the vehicle 914 may have similar configurations to the vehicle 120. The facility 920 may have a similar configuration to the monitoring target 20, the student 50 or the runner 70, except that it is stationary. The QR code 942 and the QR code 944 may have similar configurations to the QR code 22.

The vehicle 912 and the vehicle 914 may be examples of the moving object. The facility 920 may be an example of the object. The QR code 942 and the QR code 944 may be examples of the encoded code.

FIG. 10 shows schematically an example of an internal configuration of an output data generation unit 1070. The output data generation unit 1070 may be another example of the output data generation unit 270 or the output data generation unit 870. In the present embodiment, the output data generation unit 1070 includes the request acquisition unit 620, the extraction condition determination unit 630, the code information extraction unit 640, a 3D model generation unit 1050, a map information generation unit 1060, and the transmission unit 670. In the present embodiment, the members having similar configurations to the respective units of the output data generation unit 270 described with reference to FIG. 6 or the respective units of the output data generation unit 870 described with reference to FIG. 8 are denoted with the same reference signs as FIG. 6 or 8, and the detailed descriptions thereof may be omitted.

In the present embodiment, the request acquisition unit 620 is configured to acquire a request for generation of a three-dimensional model of the facility 920, as a request from an operating company of a map information service, for example. The request acquisition unit 620 may be configured to analyze the request to output information for specifying the facility 920 or identification information of the QR code 942 and QR code 944 provided on the facility 920 to the extraction condition determination unit 630. The request acquisition unit 620 may be configured to output information, which indicates contents of processing to be executed, to the extraction condition determination unit 630. Also, the request acquisition unit 620 may be configured to output information, which indicates an address of a client of the request, to the transmission unit 670.

In the present embodiment, the extraction condition determination unit 630 is configured to determine a condition relating to code information necessary to generate a three-dimensional model of the facility 920. The condition may include a condition of the code information about the QR code 942 or the QR code 944 arranged on the facility 920, and a condition of code information about an image captured for a latest specific time period.

In the present embodiment, the code information extraction unit 640 is configured to extract image data included in the code information, which meets the condition determined by the extraction condition determination unit 630, with reference to the code information storage unit 230. The code information extraction unit 640 is configured to output the extracted image data to the 3D model generation unit 1050.

In the present embodiment, the 3D model generation unit 1050 is configured to generate a three-dimensional model of the facility 920, based on the images in which the facility 920 has been captured from different positions. In processing of generating a three-dimensional model from one or more two-dimensional images, a known algorithm or any algorithm to be developed in future may be used.

In the present embodiment, the map information generation unit 1060 is configured to generate map information in which a position of the facility 920 on an electronic map and data of the three-dimensional model of the facility 920 generated by the 3D model generation unit 1050 are associated with each other. The map information generation unit 1060 may be configured to generate map information in which a position of the facility 920 on an electronic map and image data of an image in which the facility 920 is photographed are associated with each other. The map information generation unit 1060 may be configured to output the generated map information to the transmission unit 670. The map information generation unit 1060 may be configured to generate a WEB page for releasing the generated map information. In the present embodiment, the transmission unit 670 may be configured to transmit the map information generated by the map information generation unit 1060 to a client of the request.

The management system 100 has been described in detail with reference to FIGS. 1 to 10, taking as an example the case in which the QR code is arranged on a part of the management target or the monitoring target and the position or state of the management target or the monitoring target is thus managed. However, the management system 100 is not limited to the present embodiment. In another embodiment, a character string, a figure, a design and the like prepared using various types of information hiding technologies may be arranged on a part of the management target or the monitoring target. As the information hiding technology, digital watermarking, steganography and the like are exemplified. The character string may be constituted of at least one type of a number, a character and a symbol. As the design, a figure, a shape, a pattern, a change in color strength, a change in color and the like are exemplified. The character string, the figure, the design and the like prepared using various types of information hiding technologies may be examples of the encoded code.

While the embodiments of the present invention have been described, the technical scope of the invention is not limited to the above described embodiments. It is apparent to persons skilled in the art that various alterations and improvements can be added to the above-described embodiments. In addition, the matters described in the specific embodiment can be applied to other embodiments within a technically consistent range. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: communication network, 20: monitoring target, 22: QR code, 24: personal item, 50: student, 70: runner, 72: QR code, 90: facility, 100: management system, 110: management server, 120: vehicle, 122: outside-of-vehicle imaging unit, 124: image management unit, 130: monitoring device, 132: monitoring camera, 134: image management unit, 140: communication terminal, 220: code information collection unit, 230: code information storage unit, 240: request receiving unit, 250: code issuing unit, 260: registration information storage unit, 270: output data generation unit, 322: GPS signal receiving unit, 324: traveling state detection unit, 330: driving unit, 340: communication unit, 350: control unit, 352: input/output control unit, 354: vehicle control unit, 356: communication control unit, 420: image analysis unit, 422: decode unit, 424: code information generation unit, 426: code information storage unit, 430: code information transmission unit, 440: moving history storage unit, 450: request receiving unit, 460: code information extraction unit, 520: hat, 522: QR code, 524: QR code, 540: clothes, 542: QR code, 560: shoes, 562: QR code, 580: backpack, 582: QR code, 584: QR code, 620: request acquisition unit, 630: extraction condition determination unit, 640: code information extraction unit, 650: monitoring information generation unit, 660: event detection unit, 670 transmission unit, 712: vehicle, 714: vehicle, 722: image, 724: image, 850: WEB page management unit, 860: order processing unit, 870: output data generation unit, 912: vehicle, 914: vehicle, 920: facility, 942: QR code, 944: QR code, 1050: 3D model generation unit, 1060: map information generation unit, 1070: output data generation unit

What is claimed is:

1. An image management device comprising: an image data acquisition unit configured to acquire image data of an image, which is captured by an imaging unit mounted on a moving object and configured to capture an outside situation of the moving object;
a determination unit configured to analyze the image data and to determine whether an encoded code, in which predetermined information is encoded in a predetermined format, is included in the image; and
a transmission unit configured to, when it is determined that the encoded code is included in the image, transmit at least one of at least a part of the predetermined information and the image data to a code information collection device configured to collect information about the encoded code.

2. The image management device according to claim 1, wherein the predetermined information comprises at least one of identification information for identifying the encoded code and identification information for identifying an object to which the encoded code is provided.

3. The image management device according to claim 2, wherein the predetermined information further comprises information indicative of contents of processing that is to be executed when the encoded code is decoded.

4. The image management device according to claim 3, wherein the information indicative of the contents of processing to be executed comprises at least one of (i) information indicative of a type of information to be transmitted to the code information collection device, (ii) information indicative of an address of the code information collection device, and (iii) information indicative of a time zone in which information is to be transmitted to the code information collection device.

5. The image management device according to claim 2, wherein the encoded code is provided to the object in such an aspect that the encoded code is difficult to be visually recognized with naked eyes.

6. The image management device according to claim 1, further comprising: an ancillary information acquisition unit configured to acquire ancillary information indicative of at least one of a location and a time on which the image has been captured,
wherein the transmission unit is configured to further transmit the ancillary information to the code information collection device.

7. The image management device according to claim 6, wherein the ancillary information further comprises identification information for identifying the imaging unit having captured the image or identification information for identifying the moving object having the imaging unit mounted thereon.

8. The image management device according to claim 1, wherein the encoded code is constituted of a material capable of reflecting or absorbing at least one of infrared light, near-infrared light, near-ultraviolet light, and ultraviolet light, and
the imaging unit is configured to receive and image at least one of the infrared light, the near-infrared light, the near-ultraviolet light, and the ultraviolet light.

9. The image management device according to claim 1, wherein the encoded code is constituted of fine dots that are difficult to be visually recognized with naked eyes.

10. The image management device according to claim 1, wherein the encoded code is hidden by another image.

11. A non-transitory computer-readable storage medium having a program stored therein, the program being configured to cause a computer to execute an image management method comprising: acquiring image data of an image, which is captured by an imaging unit mounted on a moving object and configured to capture an outside situation of the moving object;
analyzing the image data and determining whether an encoded code, in which predetermined information is encoded in a predetermined format, is included in the image; and
transmitting at least one of at least a part of the predetermined information and the image data to a code information collection device configured to collect information about the encoded code, when it is determined that the encoded code is included in the image.

12. An image management method comprising: acquiring, by a computer, an image data of an image, which is captured by an imaging unit mounted on a moving object and configured to capture an outside situation of the moving object;
the computer analyzing the image data and determining whether an encoded code, in which predetermined information is encoded in a predetermined format, is included in the image; and
transmitting, by the computer, at least one of at least a part of the predetermined information and the image data to a code information collection device configured to collect information about the encoded code, when it is determined that the encoded code is included in the image.

13. An article to which an encoded code, in which predetermined information is encoded in a predetermined format, is provided in such an aspect that the encoded code is difficult to be visually recognized with naked eyes, the predetermined information comprising:
(i) at least one of identification information for identifying the encoded code and identification information for identifying an object to which the encoded code is provided,
(ii) information indicative of an address of a code information collection device configured to collect information about the encoded code, and
(iii) instructions for causing, when the encoded code is captured and decoded, a computer having decoded the encoded code to execute:
a procedure of acquiring information indicative of at least one of a location and a time on which the encoded code has been captured, and
a procedure of transmitting, to the code information collection device, at least one of the identification information for identifying the encoded code and the identification information for identifying an object to which the encoded code is provided, and the information indicative of at least one of the location and the time on which the encoded code has been captured.

14. The article according to claim 13, wherein the article is an article for a child, an aged person or a pet animal.
